(19) United States
(12) Patent Application Publication
(10) Pub. No.: US 2025/0161890 A1
(43) Pub. Date: May 22, 2025

(54) COMPOSITIONS COMPRISING WATER AND ULTRAFINE BUBBLES AND METHODS OF MAKING SAME

(71) Applicant: Hydrosome IP, LLC, Westmont, IL (US)

(72) Inventors: Peter A. Kozak, Bolingbrook, IL (US); John Nicholas Jackowetz, Rochester, NY (US); Carly S. Hanson, Naperville, IL (US); Kiriako D. Tsoukalas, Munster, IN (US); Bob Jacobs, Newtown, CT (US); David C. Bom, Union, KY (US)

(21) Appl. No.: 18/945,882

(22) Filed: Nov. 13, 2024

Related U.S. Application Data
(60) Provisional application No. 63/599,681, filed on Nov. 16, 2023.

(51) Int. Cl. B01F 23/2375; A23L 2/54; B01F 23/23; B01F 23/232; B01F 23/80; B01F 25/10; B01F 31/81; B01F 101/14

(52) U.S. Cl. CPC B01F 23/2375; A23L 2/54; B01F 23/232; B01F 23/238; B01F 23/806; B01F 23/808; B01F 25/10; B01F 31/81; B01F 2101/14; B01F 2215/0431; B01F 2215/044

(57) ABSTRACT

The disclosure provides compositions comprising water and ultrafine bubbles, and optionally non-gaseous solutes. The disclosure also provides methods of making and using such compositions.

### FIELD

The present disclosure generally relates to compositions that comprise water and ultrafine bubbles, which compositions have improved cell permeability, bioavailability and stability. The present disclosure also relates to methods of making such compositions.

### BACKGROUND

Ultrafine bubbles in aqueous compositions can be generated when “cavitation” occurs. There are two fundamental types of cavitation: (1) vaporous or “hard” cavitation and (2) gaseous or “soft” cavitation. Vaporous cavitation occurs when the pressure in a liquid drops below the vapor pressure of the liquid, resulting in the formation of unstable low-pressure voids or bubbles formed from vaporized particles or molecules of the liquid itself. By contrast, gaseous cavitation occurs when gases dissolved within a liquid fall out of solution with decreasing pressure, typically at pressures higher than the vapor pressure of the liquid itself-creating bubbles formed from particles or molecules of the liquid and the released gases.

Typical aqueous ultrafine bubbles are created as a result of vaporous or “hard” cavitation, when the resulting voids collapse and form shockwaves. The shockwaves facilitate the formation of ultrafine bubbles from exogenous non-dissolved gases. These ultrafine bubbles have substantially different structural, functional, and stability characteristics than ultrafine bubbles formed from “gaseous” cavitation. In aqueous compositions, ultrafine bubbles formed from “hard” cavitation (which comprise bubbles including water molecules surrounding exogenously provided gases) have substantially different physical characteristics in terms of structure, function, and stability than ultrafine bubbles formed from “soft” cavitation (which comprise bubbles including water molecules surrounding gases released from solution within the water).

With respect to aqueous compositions, it is well known that the organization of water molecules influences the stability, solubility, and bioavailability of any solutes dissolved within. As the organization of water molecules in compositions having ultrafine bubbles produced via vaporous or “hard” cavitation differs substantially from that of the organization of water molecules in compositions containing ultrafine bubbles produced via gaseous or “soft” cavitation, the stability, solubility, and bioavailability of solutes dissolved within the two compositions may be substantially different. It would be beneficial to produce aqueous compositions including water and ultrafine bubbles comprising gases released from solution in water—that is, produced via gaseous or “soft” cavitation—which compositions have improved stability, solubility, and bioavailability as compared to compositions including no ultrafine bubbles or solutions comprising or consisting of aqueous ultrafine bubbles formed via vaporous or “hard” cavitation. There also exists a need for compositions that comprise water, ultrafine bubbles comprising gases released from solution in water, and a non-gaseous solute that have improved bioavailability, solubility, and/or stability.

### SUMMARY

The present disclosure generally relates to compositions comprising water and ultrafine bubbles. The ultrafine bubbles may comprise water and gases released from solution in water. In some embodiments, the ultrafine bubbles are formed from gases released from solution in water. In some embodiments, the gases released from solution in water to form the ultrafine bubbles are released via gaseous cavitation. In some embodiments, the gases are released as a result of gaseous cavitation. In some embodiments, the gases are released when the water in the composition is subjected to a combination of hydrodynamic cavitation, shear forces, and low-pressure/room temperature boiling to form the ultrafine bubbles.

In some embodiments, the ultrafine bubbles are present in the composition at a concentration of up to 10¹⁰ ultrafine bubbles/mL, as measured via nanoparticle tracking analysis (NTA), which is able to detect bubbles with diameters of 50 to 1000 nanometers. In some embodiments, the ultrafine bubbles are present in the composition at a range of 10 to 10² ultrafine bubbles/mL, 10² to 10³ ultrafine bubbles/mL, 10³ to 10⁴ ultrafine bubbles/mL, 10⁴ to 10⁵ ultrafine bubbles/mL, 10⁵ to 10⁶ ultrafine bubbles/mL, 10⁶ to 10⁷ ultrafine bubbles/mL, 10⁷ to 10⁸ ultrafine bubbles/mL, 10⁸ to 10⁹ ultrafine bubbles/mL, or 10⁹ to 10¹⁰ ultrafine bubbles/mL.

In certain embodiments in which the water of the composition is enriched via microbubble generation prior to generation of the ultrafine bubbles in the composition, the concentration of ultrafine bubbles in the resulting composition may be higher. In such embodiments, the ultrafine bubbles may be present in the composition at a range of 10¹⁰ to 10¹¹ ultrafine bubbles/mL. In some embodiments, the ultrafine bubbles are present in the composition at a range of 10¹⁰ to 10¹¹ ultrafine bubbles/mL

In certain embodiments in which the water of the composition is enriched via microbubble generation prior to generation of the ultrafine bubbles in the composition, the concentration of ultrafine bubbles in the resulting composition may be same, but the composition of gas within the bubble is different, allowing the bubble composition to be tailored.

In some embodiments, the ultrafine bubbles have a median diameter of between about 2 to about 400 nanometers. In another embodiment, the ultrafine bubbles have a median diameter of between about 2 to about 10 nanometers (e.g., about 2 nanometers, about 3 nanometers, about 4 nanometers, about 5 nanometers, about 6 nanometers, about 7 nanometers, about 8 nanometers, about 9 nanometers, or about 10 nanometers). In other embodiments, the ultrafine bubbles have a median diameter of between about 10 to about 15 nanometers, about 15 to about 20 nanometers, or about 20 to about 25 nanometers. In other embodiments, the ultrafine bubbles have a median diameter of between about 10 to about 50 nanometers, about 20 to about 50 nanometers, about 30 to about 50 nanometers, or about 40 to about 50 nanometers. In still other embodiments, the ultrafine bubbles have a median diameter of between about 50 to about 100 nanometers. In yet further embodiments, the ultrafine bubbles have a median diameter of between about 100 to about 200 nanometers, about 150 to about 200 nanometers, about 200 to about 300 nanometers, about 250 to about 300 nanometers, or about 300 to about 400 nanometers.

In some embodiments, the water is selected from DI water, ultrapure water, tap water, groundwater (e.g., well water), surface water, and reverse osmosis water.

In some embodiments, the water has an oxidative reduction potential from about −200 mV to about 800 mV (e.g., about −200 mV, about −195 mV, about −190 mV, about −185 mV, about −180 mV, about −175 mV, about −170 mV, about −165 mV, about −160 mV, about −155 mV, about −150 mV, about −145 mV, about −140 mV, about −135 mV, about −130 mV, about −125 mV, about −120 mV, about −115 mV, about −110 mV, about −105 mV, about −100 mV, about −95 mV, about-90 mV, about −85 mV, about −80 mV, about −75 mV, about −70 mV, about −65 mV, about −60 mV, about −55 mV, about −50 mV, about −45 mV, about −40 mV, about −35 mV, about −30 mV, about-25 mV, about −20 mV, about −15 mV, about −10 mV, about −5 mV, about 0 mV, about 5 mV, about 10 mV, about 15 mV, about 20 mV, about 25 mV, about 30 mV, about 35 mV, about 40 mV, about 45 mV, about 50 mV, about 55 mV, about 60 mV, about 65 mV, about 70 mV, about 75 mV, about 80 mV, about 85 mV, about 90 mV, about 95 mV, about 100 mV, about 105 mV, about 110 mV, about 115 mV, about 120 mV, about 125 mV, about 130 mV, about 135 mV, about 140 mV, about 145 mV, about 150 mV, about 155 mV, about 160 mV, about 165 mV, about 170 mV, about 175 mV, about 180 mV, about 185 mV, about 190 mV, about 195 mV, about 200 mV, about 205 mV, about 210 mV, about 215 mV, about 220 mV, about 225 mV, about 230 mV, about 235 mV, about 240 mV, about 245 mV, about 250 mV, about 255 mV, about 260 mV, about 265 mV, about 275 mV, about 280 mV, about 290 mV, about 295 mV, about 300 mV, about 305 mV, about 310 mV, 315 mV, 320 mV, 325 mV, 330 mV, 335 mV, 340 mV, 345 mV, 350 mV, 355 mV, 360 mV, 365 mV, 370 mV, 375 mV, 380 mV, 385 mV, 390 mV, 395 mV, 400 mV, 405 mV, 410 mV, 415 mV, 420 mV, 425 mV, 430 mV, 435 mV, 440 mV, 445 mV, 450 mV, 455 mV, 460 mV, 465 mV, 470 mV, 475 mV, 480 mV, 485 mV, 490 mV, 495 mV, 500 mV, 505 mV, 510 mV, 515 mV, 520 mV, 525 mV, 530 mV, 535 mV, 540 mV, 545 mV, 550 mV, 555 mV, 560 mV, 565 mV, 570 mV, 575 mV, 580 mV, 585 mV, 590 mV, 595 mV, about 600 mV, about 605 mV, about 610 mV, about 615 mV, about 620 mV, about 625 mV, about 630 mV, about 635 mV, about 640 mV, about 645 mV, about 650 mV, about 655 mV, about 660 mV, about 665 mV, about 670 mV, about 675 mV, about 680 mV, about 685 mV, about 690 mV, about 695 mV, about 700 mV, about 705 mV, about 710 mV, about 715 mV, about 720 mV, about 725 mV, about 730 mV, about 735 mV, about 740 mV, about 745 mV, about 750 mV, about 755 mV, about 760 mV, about 765 mV, about 770 mV, about 775 mV, about 780 mV, about 785 mV, about 790 mV, about 795 mV, or about 800 mV). In still further embodiments, the pH of the water is between about 4 to about 8 (e.g., about 4, about 5, about 6, about 7, or about 8).

In some embodiments, the composition further comprises at least one non-gaseous solute (e.g, a solute dissolved in the composition). In further embodiments, the at least one non-gaseous solute is dissolved within, surrounded by, or stabilized by the ultrafine bubbles. In particular embodiments, the composition increases cell permeability and/or bioavailability of the at least one dissolved non-gaseous solute. In some embodiments, the at least one non-gaseous solute dissolved within or stabilized by the ultrafine bubbles has improved bioavailability relative to a solute not dissolved within or stabilized by the ultrafine bubbles. In further embodiments the at least one non-gaseous solute dissolved within or stabilized by the ultrafine bubbles has improved stability relative to a solute not dissolved within or stabilized by the ultrafine bubbles. In still further embodiments, the at least one non-gaseous solute dissolved within or stabilized by the ultrafine bubbles has improved solubility relative to a solute not dissolved within or stabilized by the ultrafine bubbles.

In some embodiments, the at least one non-gaseous solute dissolved within, surrounded by, and/or stabilized by the ultrafine bubbles comprises a small molecule drug, a protein, a peptide, or a combination thereof. In some embodiments, the at least one non-gaseous solute dissolved within or stabilized by the ultrafine bubbles comprises a cellular detoxification agent, a hydration agent, an anti-inflammatory agent, a neuroprotective agent, a neuromodulatory agent, or an anti-tumorigenic agent.

In some embodiments, the composition is used to deliver the at least one non-gaseous solute to a cell (e.g., the interior of the cell). In some embodiments, the cell is a plant or an animal cell such as a human cell. In some embodiments, the cell is a prokaryotic or a eukaryotic cell.

In some embodiments, the ultrafine bubbles (e.g., ultrafine bubbles comprising gases released from solution in water) are concentrated within the composition via rotary evaporation and/or cross flow filtration.

In some embodiments, the compositions and/or ultrafine bubbles are stable and/or exhibit biological efficacy for at least six months, for at least one year, for at least 2 years, for at least 3 years, for at least 4 years, or for at least 5 years.

In another aspect disclosed herein, a method for producing a composition comprising water and ultrafine bubbles, wherein the ultrafine bubbles are at a concentration of up to 10¹⁰ ultrafine bubbles/mL is provided. The method includes subjecting water to a combination of hydrodynamic cavitation, shear forces, and thin film boiling to produce ultrafine bubbles formed by release of dissolved gases from the water. In some embodiments, the water is selected from DI water, ultrapure water, tap water, groundwater (e.g., well water), surface water, and reverse osmosis water. In particular embodiments, the water is ultrapure water. In some embodiments, the ultrafine bubbles are present in the composition at a range of 10 to 10² ultrafine bubbles/mL, 10² to 10³ ultrafine bubbles/mL, 10³ to 10⁴ ultrafine bubbles/mL, 10⁴ to 10⁵ ultrafine bubbles/mL, 10⁵ to 10⁶ ultrafine bubbles/mL, 10⁶ to 10⁷ ultrafine bubbles/mL, 10⁷ to 10⁸ ultrafine bubbles/mL, 10⁸ to 10⁹ ultrafine bubbles/mL, or 10⁹ to 10¹⁰ ultrafine bubbles/mL.

In an embodiment, the method further comprises dissolving at least one non-gaseous solute into the composition. In some embodiments, the at least one non-gaseous solute is dissolved within, surrounded by, and/or stabilized by the ultrafine bubbles.

In some embodiments, the methods further comprise concentrating the ultrafine bubbles within the composition via rotary evaporation or cross flow filtration.

In another aspect, a composition comprising water and ultrafine bubbles is provided. The ultrafine bubbles comprise water and gases released from solution in water. In some embodiments, the ultrafine bubbles are present in the composition at a concentration of up to 10¹⁰ ultrafine bubbles/mL.

In some embodiments, the ultrafine bubbles further comprise gases released from microbubbles in the water. In some embodiments, the ultrafine bubbles have a median diameter of between about 2 to about 400 nanometers. In some embodiments, the ultrafine bubbles remain stable within the composition for at least two years. In some embodiments, the ultrafine bubbles remain stable within the composition for at least 2.5 years. In some embodiments, the ultrafine bubbles are concentrated within the composition via rotary evaporation and/or cross flow filtration. In particular embodiments, the concentrated ultrafine bubbles are stable within the composition for at least 2 years.

In some embodiments, the water is selected from DI water, ultrapure water, tap water, groundwater, surface water, and reverse osmosis water. In particular embodiments, the water is ultrapure water. In some embodiments, the water has a resistivity between about 17 to about 18.2 meg-ohm cm. In some embodiments, the water has a pH of between about 3 to about 7. In the water has an oxidative reduction potential of about −200 mV to about 800 mV.

In some embodiments, the composition further comprising at least one non-gaseous solute. In some embodiments, the at least one non-gaseous solute is dissolved within, surrounded by, and/or stabilized by the ultrafine bubbles. In some embodiments, the at least one non-gaseous solute is stable within the composition for at least 2 years.

In some embodiments, the composition increases cell permeability and/or bioavailability of the at least one non-gaseous solute.

In some embodiments, the composition has a zeta potential of between |0 and 40| mV. In particular embodiments, the composition further comprising at least one non-gaseous solute.

In another aspect, a method for producing a composition comprising water and ultrafine bubbles is provided. The method includes generating and adding microbubbles to a source of water. Then, the water with added microbubbles is subjected to one or more of hydrodynamic cavitation, shear forces, and low pressure/room temperature boiling to produce ultrafine bubbles formed by release of dissolved gases from the water and/or the microbubbles. The resulting composition has formed ultrafine bubbles at a concentration of up to 1011 ultrafine bubbles/mL.

In some embodiments, the source of water is selected from DI water, ultrapure water, tap water, groundwater, surface water, and reverse osmosis water.

In some embodiments, the method includes adding at least one non-gaseous solute. In some embodiments, the at least one non-gaseous solute is dissolved within, surrounded by, and/or stabilized by the ultrafine bubbles. In particular embodiments, the at least one non-gaseous solute is added before the step of subjecting the water to the one or more of hydrodynamic cavitation, shear forces, and low pressure/room temperature boiling to produce the ultrafine bubbles. In particular embodiments, the at least one non-gaseous solute is added after the step of subjecting the water to the one or more of hydrodynamic cavitation, shear forces, and low pressure/room temperature boiling to produce the ultrafine bubbles.

In some embodiments, the method includes concentrating the ultrafine bubbles within the composition via rotary evaporation or cross flow filtration.

In some embodiments, the method further comprises the step of adding the ultrafine bubbles of the composition comprising water and ultrafine bubbles to a different source of water.

In some embodiments, the method further comprises the step of sparging the water with one or more gases before the step of subjecting the water to the one or more of hydrodynamic cavitation, shear forces, and low pressure/room temperature boiling to produce the ultrafine bubbles.

In some embodiments, the gases sparged into the water include hydrogen, oxygen, nitrogen, nitrous oxide, carbon dioxide, or some combination of said gases.

In another aspect, a method designed to preserve ultrafine bubbles indefinitely within a solution is provided. The formulation consists of an ultrafine bubble suspension combined with an ingredient that increases the viscosity of the final product. By enhancing the viscosity, the mobility of the ultrafine bubbles is restricted, effectively preventing them from bursting or coalescing. This stabilization mechanism ensures that the ultrafine bubbles remain uniformly dispersed within the solution over extended periods, making the formulation suitable for various applications, including skincare, pharmaceutical, and consumable products.

### BRIEF DESCRIPTION OF THE FIGURES

FIG. 1 shows a diagram of a system (101) and a method for making compositions including water and ultrafine bubbles in accordance with embodiments of the disclosure.

FIG. 2 shows a diagram of a system (202) and a method for making compositions including water and ultrafine bubbles utilizing a partial vacuum in accordance with embodiments of the disclosure.

FIG. 3 shows a diagram of multiple systems (302) and a method for making compositions including water and ultrafine bubbles in accordance with embodiments of the disclosure.

FIG. 4 illustrates images of ultrafine bubbles produced through the described methods using liquid cell transmission electron microscopy (LC-TEM) techniques by flowing the suspension through a commercially available flow cell.

FIG. 5 illustrates images of ultrafine bubbles produced through the described methods using liquid cell transmission electron microscopy (LC-TEM) techniques capturing a portion of the suspension within graphene sheet envelopes.

FIG. 6 displays a graph of time-dependent increase in hydration for water beverage compositions in accordance with embodiments of the disclosure.

### DETAILED DESCRIPTION

The present disclosure provides compositions (e.g., aqueous compositions) that comprise ultrafine bubbles, and optionally, at least one non-gaseous solute, and methods of making and using the same. The ultrafine bubbles can advantageously be used to hydrate cells and/or to dissolve, surround, or stabilize a non-gaseous solute (e.g., an organic chemical, an inorganic chemical, a protein, a peptide, a sugar, an oligosaccharide, a polysaccharide, a synthetic polymer, a fat, a wax, an oil, a colloid, a fatty acid, a DNA nucleotide, a polynucleotide, an RNA polynucleotide, a pharmaceutical drug, a fertilizer, a plant nutrient, or an electrolyte) and optionally used to deliver the solute across a cell membrane to exert its effect. As such, the disclosed compositions provide surprising and unexpected advantages in various applications, including medical and agricultural applications, based, for example, on the improved bioavailability, solubility, and/or stability. Indeed, the inventors have surprisingly discovered that aqueous compositions that comprise a low concentration of ultrafine bubbles (e.g., at a concentration of up to 10⁸ ultrafine bubbles/mL) exert improved/increased bioavailability, solubility, permeability with respect to biological membranes, and/or stability than previously anticipated, perhaps even as compared to compositions that comprise a higher concentration of ultrafine bubbles (e.g., more than 10⁸ ultrafine bubbles/mL).

Also provided by the present disclosure are methods for making compositions comprising water and ultrafine bubbles comprising or consisting essentially of water and gases released from solution in water, optionally including steps for dissolving, surrounding, and/or stabilizing at least one non-gaseous solute with the ultrafine bubbles.

The ultrafine bubbles may be used to dissolve, surround, and/or stabilize nutrients, foods, pharmaceuticals, biologic drugs, biotechnology products, inorganic or organic chemicals. Additionally, in some embodiments, the ultrafine bubbles may be used to dissolve, surround, and/or stabilize a solute for human and/or animal nutrition, or agriculture production. In still further embodiments, the ultrafine bubbles may be used to dissolve, surround, and/or stabilize a solute in a hydration, sports, or energy drink. In other embodiments, the ultrafine bubbles may be used as a means for creating oral drug formulations with improved drug pharmacokinetics, higher drug bioavailability, increased drug safety and/or higher selective potency. Further, in other embodiments, the ultrafine bubbles may be used to dissolve, surround, and/or stabilize a drug or a biotechnology product.

In some embodiments, the disclosure provides compositions comprising ultrafine bubbles that comprise or consist essentially of water and gases released from solution in water and a non-gaseous solute, wherein the ultrafine bubbles dissolve, surround, and/or stabilize the non-gaseous solute.

In certain embodiments, the ultrafine bubbles in the composition have a median diameter of between about 2 to about 400 nanometers. In another embodiment, the ultrafine bubbles have a median diameter of between about 2 to about 10 nanometers (e.g., about 2 nanometers, about 3 nanometers, about 4 nanometers, about 5 nanometers, about 6 nanometers, about 7 nanometers, about 8 nanometers, about 9 nanometers, or about 10 nanometers). In other embodiments, the ultrafine bubbles have a median diameter of between about 10 to about 20 nanometers or about 15 to about 20 nanometers, or about 20 to about 25 nanometers. In other embodiments, the ultrafine bubbles have a median diameter of between about 10 to about 50 nanometers, about 20 to about 50 nanometers, about 30 to about 50 nanometers, or about 40 to about 50 nanometers. In still other embodiments, the ultrafine bubbles have a median diameter of between about 50 to about 100 nanometers. In yet further embodiments, the ultrafine bubbles have a median diameter of between about 100 to about 200 nanometers, about 150 to about 200 nanometers, about 200 to about 300 nanometers, about 250 to about 300 nanometers, or about 300 to about 400 nanometers.

The present disclosure also provides compositions wherein 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100% of the composition includes ultrafine bubbles (e.g., ultrafine bubbles that comprise or consist essentially of water and gases released from solution in water), and a non-gaseous solute, wherein the ultrafine bubbles dissolve, surround, and/or stabilize the solute.

Without being bound by theory, it is believed the compositions as disclosed herein provide for improved bioavailability, solubility, and/or stability of the ultrafine bubbles comprising or consisting essentially of water and gases released from solution in water, as well as improved bioavailability, solubility, and/or stability of any dissolved the solutes because the ultrafine bubbles are produced from “soft” or gaseous cavitation rather than “hard” or vaporous cavitation processes. The disclosed ultrafine bubbles are believed to be (a) nucleated in the low-pressure vicinity surrounding the cavitation core, (b) sheared-off bubbles from the cavitation core itself, or (c) produced via low pressure/room temperature boiling at the core surface, such that, in the presence of turbulence and high shear stresses near the core, ultrafine bubbles are broken into smaller ultrafine bubbles through deformation (due to drag forces). The resulting compositions incorporating ultrafine bubbles demonstrate improved efficacy in dissolving and/or stabilizing solutes, even when measured by NTA at concentrations of 10⁷ ultrafine bubbles/mL or lower. This suggests better performance at lower concentrations than expected, or possibly the presence of a sub-population of ultrafine bubbles below 50 nm that cannot be detected by NTA. Such compositions also exhibit enhanced stability over other solutions incorporating ultrafine bubbles or ultrafine bubbles produced via other means, as they can be concentrated by several orders of magnitude via rotary evaporation or crossflow filtration without ultrafine bubble loss or solute dissolution, and can even remain bottled for up to 10 years without loss of ultrafine bubble concentration or dissolution of solutes.

In cases where numerical values are indicated in the context of the present disclosure, the skilled person will understand that the technical effect of the feature in question is ensured within an interval of accuracy, which typically encompasses a deviation of the numerical value given of ±10%, and preferably of ±5%. At the very least, and not as an attempt to limit the application of the doctrine of equivalents to the scope of the claims, each numerical parameter should at least be construed in light of the number of reported significant digits and by applying ordinary rounding techniques.

Unless otherwise indicated, all numbers expressing quantities of ingredients, properties such as molecular weight and median size, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure.

It is to be understood that the embodiments of the disclosure disclosed herein are illustrative of the principles of the present disclosure. Other modifications that can be employed are within the scope of the disclosure. Thus, by way of example, but not of limitation, alternative configurations of the present disclosure can be utilized in accordance with the teachings herein. Accordingly, the present disclosure is not limited to that precisely as shown and described.

Further definitions of terms will be given in the following in the context of which the terms are used. The following terms or definitions are provided solely to aid in the understanding of the invention. These definitions should not be construed to have a scope less than understood by a person of ordinary skill in the art.

As used herein, an “ultrafine bubble” refers to an assembly of water molecules, with a diameter less than one micron, bonded with or otherwise associated with one another by electrostatic forces, such as hydrogen bonding, ionic bonding, van der Waals forces, or the like, surrounding gases (e.g., gases released from solution in water). In some cases according to the disclosure, an ultrafine bubble further comprises a non-gaseous solute associated with the water molecules and dissolved within, surrounded by, and/or stabilized by the ultrafine bubble.

As used herein, a non-gaseous “solute” means a substance or particle that is fully or partially dissolved in water. In embodiments, a solute of the disclosure is dissolved within, surrounded by, and/or stabilized by ultrafine bubbles of the disclosure. A non-gaseous solute according to the disclosure comprises, without limitation, a polar or non-polar substance, a liquid, a solid, a lipid, a protein, a peptide, a nucleic acid, an organic compound, an inorganic compound, or any combination thereof.

As used herein, a “hydration agent” means, a substance that promotes the hydration of, without exclusion, a cell, a plant, a human or non-human animal, or a soil sample.

As used herein, “ultrapure water” means water prepared according to one or more of the described embodiments of the disclosure. In particular, ultrapure water refers to water prepared by methods and processes disclosed herein, or water characterized as being completely free of (e.g., does not contain any detectable amount), or substantially free of (e.g., 70%, 80%, 90%, or 95% free of), one or more impurities or contaminants.

As used herein, “bioavailability” refers to the physiological availability of a given amount of a solute as distinct from its chemical potency. For example, bioavailability refers to the proportion of an administered solute that is absorbed into the bloodstream of a mammal or is absorbed into the tissues of a plant. Bioavailability also refers to the ability of an ultrafine bubble, solute, particle, ultrafine bubble-dissolved solute, ultrafine bubble-surrounded solute, ultrafine bubble-stabilized solute, or combination thereof, to access a biological target, e.g., by crossing a biological membrane or by interacting with a biological receptor or other binding partner.

As used herein, a “microbubble” refers to an assembly of water molecules with a diameter greater than one micron and less than one millimeter, surrounding gases (e.g., generated gases added or bubbled into a water source).

### Compositions Comprising Ultrafine Bubbles

The disclosure provides compositions and solutions comprising ultrafine bubbles (e.g., ultrafine bubbles comprising or consisting essentially of water and gases released from solution in water), and optionally a non-gaseous solute dissolved, surrounded, and/or stabilized by the ultrafine bubbles, wherein the ultrafine bubbles are present in the composition at a concentration of up to 10¹⁰ ultrafine bubbles/mL (e.g., at a range of 10 to 10² ultrafine bubbles/mL, 10² to 10³ ultrafine bubbles/mL, 10³ to 10⁴ ultrafine bubbles/mL, 10⁴ to 10⁵ ultrafine bubbles/mL, 10⁵ to 10⁶ ultrafine bubbles/mL, 10⁶ to 10⁷ ultrafine bubbles/mL, or 10⁷ to 10⁸ ultrafine bubbles/mL, or 10⁸ to 10⁹ ultrafine bubbles/mL, or 10⁹ to 10¹⁰ ultrafine bubbles/mL).

In some embodiments, the ultrafine bubbles may have a median size of between about 2 to about 400 nanometers.

In some embodiments, the water comprises water substantially free of or completely free of contaminants (e.g., an impurity). The water may be ultrapure water. As used herein, a “contaminant” is a foreign substance not intentionally added to the water in the compositions produced according to the disclosure. Thus, water substantially free of contaminants contains undetectable levels/amounts of, for example, the following contaminants: (a) pathogenic bacteria (e.g., fecal coliform), viruses (e.g., hepatitis viruses, hemorrhagic viruses, retroviruses such as AIDS virus), fungi, mycoplasma, protozoa, prokaryotes, protists, parasites, microorganisms causing infectious diseases, and their spores, eggs, DNA, RNA, or related reproductive constituents, prions, (b) toxic biochemicals including toxic proteins, lipids, carbohydrates, toxic nucleic acids, known carcinogens, and chemotherapy drugs; (c) toxic inorganic chemicals (soluble and insoluble in water and including toxic heavy metals) and their particles; (d) toxic organic chemicals (soluble and insoluble in water and including pesticides) and their particles; (e) non-water organic liquids (miscible and immiscible); (f) radioactive minerals, or (g) toxic gases including ammonia, arsenic pentafluoride, arsine, bis(trifluoromethyl) peroxide, boron tribromide, boron trichloride, boron trifluoride, bromine, bromine chloride, boromethane, carbon monoxide, chlorine, chlorine pentafluoride, chlorine trifluoride, chloropicrin, cyanogen, cyanogen chloride, diazomethane, diborane, dichloroacetylene, dichlorosilane, fluorine, formaldehyde, germane, hexylethyl tetraphosphate, hydrogen azide, hydrogen cyanide, hydrogen selenide, hydrogen sulfide, hydrogen telluride, nickel tetracarbonyl, nitrogen dioxide, osmium tetroxide, oxygen difluoride, perfluroisobuytlene, phosgene, phosphine, phosphorus pentafluoride, selenium hexafluoride, silicon hexafluoride, silicon tetrachloride, stilbene, disulfur decafluoride, sulfur tetrafluoride, tellurium hexafluoride, tetraethyl pyrophosphate, tetraethyl dithiopyrophosphate, trifluoroacetyl chloride, tungsten hexafluoride, and radon.

The water may be prepared by processes known in the art and used as a starting material for generating the compositions and solutions comprising ultrafine bubbles as disclosed herein. The water may be prepared by carbon filtration, by slow sand filtration, by reverse osmosis, by electro-deionization treatment, by ultraviolet light exposure, or by a combination comprising two or more of the processes described herein. For example, the water may be prepared by a sequential process comprising each of carbon filtration, slow sand filtration, reverse osmosis, electro-deionization treatment, and ultraviolet light exposure. Alternatively, the water may be prepared according to one or more of the processes described herein in combination with other methods of water purification known in the art but not expressly recited herein.

The water may be prepared by a process comprising the steps of: filtering a volume of water with a carbon filter to produce an amount of water with a low chlorine content; removing ions in the carbon filtered water by a reverse osmosis process to produce a supply of a deionized water; electro-deionizing the supply of the deionized water from the reverse osmosis process to make a water supply; testing the resistivity of the water to determine if the resistivity of the water is between about 17 meg-ohm cm to about 18.2 meg-ohm cm; repeating a process step for preparing the water and retesting the resistivity of the water until the water has a measured resistivity of between about 17 meg-ohm cm to about 18.2 meg-ohm cm; irradiating the supply of the water having a measured resistivity of between about 17 meg-ohm cm to about 18.2 meg-ohm cm with ultraviolet light to make a sterilized water supply; and storing the sterilized water in a stainless steel container until sterilized water is needed to be added in the process to make an composition comprising ultrafine bubbles.

The water may be purified of contaminants including, for example, organic and inorganic compounds; dissolved and particulate matter; volatile and non-volatile matter, reactive and inert matter; hydrophilic and hydrophobic matter.

The water of the disclosure may have a high oxidative reduction potential including, for example, about 80 to about 600 mV. Further, the pH of the water may be between about 3 to about 7, preferably about 4 to about 6 and the resistivity of the water may be between about 17 to about 18.2 meg-ohm cm.

In some embodiments, the compositions comprise ultrafine bubbles comprising or consisting essentially of water and gases released from solution in water, wherein the ultrafine bubbles optionally dissolve, surround, and/or stabilize a non-gaseous solute, and wherein the water has an oxidative reduction potential between about −200 mV and 800 mV. In further embodiments, the oxidative reduction potential of the water is about −200 mV to about −180 mV, about-180 mV to about −160 mV, about −160 mV to about −140 mV, about −140 mV to about −120 mV, about −120 mV to about −100 mV, about −100 mV to about −80 mV, about −80 mV to about −60 mV, about −60 mV to about −40 mV, about −40 mV to about −20 mV, about −20 mV to about 0 mV, about 0 mV to about 20 mV, about 20 mV to about 40 mV, about 40 mV to about 60 mV, about 60 mV to about 80 mV, about 80 mV to about 100 mV, about 100 mV to about 120 mV, about 120 mV to about 140 mV, about 140 mV to about 160 mV, about 160 mV to about 180 mV, about 180 mV to about 200 mV, about 200 mV to about 220 mV, about 220 mV to about 240 mV, about 240 mV to about 260 mV, about 260 mV to about 280 mV, about 280 mV to about 300 mV. about 300 mV to about 320 mV, about 320 mV to about 340 mV, about 340 mV to about 360 mV, about 360 mV to about 380 mV, about 380 mV to about 400 mV, about 400 mV to about 420 mV, about 420 mV to about 440 mV, about 440 mV to about 460 mV, about 460 mV to about 480 mV, about 480 mV to about 500 mV, about 500 mV to about 520 mV, about 520 mV to about 540 mV, about 540 mV to about 560 mV, about 560 mV to about 580 mV, or about 580 mV to about 600 mV, about 600 mV to about 620 mV, about 620 mV to about 640 mV, about 640 mV to about 660 mV, about 660 mV to about 680 mV, about 680 mV to about 700 mV, about 700 mV to about 720 mV, about 720 mV to about 740 mV, about 740 mV to about 760 mV, about 760 mV to about 780 mV, or about 780 mV to about 800 mV. In still further embodiments, the pH of the water is between about 4 to about 5, about 5 to about 6, or about 6 to about 7.

In some embodiments, the compositions comprise ultrafine bubbles comprising or consisting essentially of water and gases released from solution in water, wherein the ultrafine bubbles optionally dissolve, surround, and/or stabilize a non-gaseous solute, and wherein the composition has a zeta potential of between about absolute value 0 and 40. In further embodiments, the zeta potential of the composition is between about −40 mV to about 0 mV, although in most embodiments the average zeta potential falls between −15 to −10 mV. In still further embodiments, the zeta potential of the composition is between about −40 mV to about −35 mV, about −35 to about −30 mV, about −30 to about −25 mV, about −25 to about −20 mV, about −20 mV to about −15 mV, about −15 mV to about −10 mV, about −10 mV to about −5 mV, about −5 mV to about 0 mV. The inventors have surprisingly found that despite relatively low average absolute value zeta potentials of the compositions (e.g., typical ultrafine bubble compositions have zeta potentials of around absolute value 30 mV, significantly higher than the average absolute value zeta potentials of the compositions herein), the ultrafine bubble compositions according to the disclosure herein achieve superior stability results over ultrafine bubbles formed by alternative means with higher absolute value zeta potentials.

A non-gaseous solute dissolved within, surrounded by, and/or stabilized by ultrafine bubbles (e.g., ultrafine bubbles that comprise or consist essentially of water and gases released from solution in water) may be a small molecule drug, a protein, a peptide, or a combination thereof. In some embodiments, the non-gaseous solute comprises a cellular detoxification agent, a hydration agent, an anti-inflammatory agent, a neuroprotective agent, a neuromodulatory agent, or an anti-tumorigenic agent. In still other embodiments, the non-gaseous solute improves ATP production.

Non-gaseous solutes suitable for use in embodiments of the disclosure may have an approximately round geometry, a flat plate geometry, a cube geometry, a rod-like geometry, a hollow geometry, and/or a semi-hollow geometry. In some embodiments, a solute dissolved by, surrounded by, and/or stabilized by the ultrafine bubbles may comprise a primary solute, a mixture of a first solute and a second solute, or a plurality of solutes. The solutes may have one or more additional associated solutes, such as a surface coating, as a subsurface coating, or in a complex with other solutes. The solutes may comprise a liquid, a solid, or be a colloidal system with a colloid and a dispersing agent.

In some embodiments, the non-gaseous solute comprises an organic chemical, an inorganic chemical, a fat, a peptide, a sugar, a synthetic polymer including polyethylene, nylon, polypropylene, a wax, an oil, a colloid, an oligosaccharide, a polysaccharide, a protein, a fatty acid, a DNA nucleotide, a polynucleotide, an RNA polynucleotide, a pharmaceutical drug, a surfactant, a hydrogel, a hydrophilic substance catalyst, a free radical scavenger, an ion chelator, a paramagnetic substance, a magnetic field sensitive substance, a radioactive substance, a radiocontrast agent, an ultrasound contrast agent, a cerium oxide, an odorant, a perfume, a pheromone, a hormone, a cytokine, an interleukin, an antibody, a biological cell organelle, an intact biological, a fluorescent compound, a polymerase, a PCR enzyme, a catalyst, or any combination thereof.

In certain embodiments, a non-gaseous solute dissolved within, surrounded by, and/or stabilized by the ultrafine bubbles (e.g., ultrafine bubbles that comprise or consist essentially of water and gases released from solution in water) is an ion of an ionizable salt. In certain embodiments, the ion is an aluminum ion, ammonium ion, antimony ion, arsenic ion, barium ion, beryllium ion, bismuth ion, boron ion, bromide ion, cadmium ion, calcium ion, cerium ion, cesium cation, chloride ion, chromium ion, cobalt ion, copper ion, dysprosium ion, erbium ion, europium ion, fluoride ion, gadolinium ion, gallium ion, germanium ion, gold ion, hafnium ion, holmium ion, indium ion, iodine ion, iridium ion, iron ion, lanthanum ion, lead ion, lithium ion, lutetium ion, magnesium ion, manganese ion, mercury ion, molybdenum ion, neodymium ion, nickel ion, niobium ion, osmium ion, palladium ion, phosphorus ion, platinum ion, potassium ion, praseodymium ion, rhenium ion, rhodium ion, rubidium ion, ruthenium ion, samarium ion, scandium ion, selenium ion, silicon ion, silver ion, sodium ion, strontium ion, sulfate ion, tantalum ion, tellurium ion, terbium ion, thallium ion, thorium ion, thulium ion, tin ion, titanium ion, tungsten ion, vanadium ion, ytterbium ion, yttrium ion, zinc ion, or zirconium ion.

The ultrafine bubbles (e.g., ultrafine bubbles that comprise or consist essentially of water and gases released from solution in water) have a median diameter of between about 2 to about 400 nanometers. In certain embodiments, the ultrafine bubbles have a median diameter of about 1 nanometers, about 2 nanometers, about 3 nanometers, about 4 nanometers, about 5 nanometers, about 6 nanometers, about 7 nanometers, about 8 nanometers, about 9 nanometers, about 10 nanometers, about 11 nanometers, about 12 nanometers, about 13 nanometers, about 14 nanometers, about 15 nanometers, about 16 nanometers, about 17 nanometers, about 18 nanometers, about 19 nanometers, or about 20 nanometers. In other embodiments, the ultrafine bubbles according to the disclosure comprise a median diameter of about 20 nanometers, about 22 nanometers, about 24 nanometers, about 26 nanometers, about 28 nanometers, or about 30 nanometers. In still other embodiments, the ultrafine bubbles according to the disclosure comprise a median diameter of about 35 nanometers, about 40 nanometers, about 45 nanometers, about 50 nanometers, about 60 nanometers, about 70 nanometers, about 80 nanometers, about 90 nanometers, or about 100 nanometers. In other embodiments, the ultrafine bubbles according to the disclosure comprise a median diameter of about 110 nm, about 120 nm, about 130 nm, about 140 nm, about 150 nm, about 160 nm, about 170 nm, about 180 nm, about 200 nm, about 210 nm, about 220 nm, about 230 nm, about 240 nm, about 250 nm, about 260 nm, about 270 nm, about 280 nm, about 300 nm, 310 nm, about 320 nm, about 330 nm, about 340 nm, about 350 nm, about 360 nm, about 370 nm, about 380 nm, or about 400 nm.

In some embodiments, the ultrafine bubbles comprise on average about 20, about 25, about 30, about 35, about 40, about 45, about 50, about 60, about 70, about 80, about 90, about 100, about 110, about 120, about 130, about 140, about 150, about 160, about 170, about 180, about 190, about 200, about 210, about 220, about 230, about 240, about 250, about 260, about 270, about 280, about 290, about 300, about 310, about 320, about 330, about 340, about 350, about 360, about 370, about 380, about 390, about 400, about 410, about 420, about 430, about 440, about 450, about 460, about 470, about 480, about 490, or about 500 water molecules. In other embodiments, the ultrafine bubble comprises between about 50 and about 100 water molecules, about 100 to about 150 water molecules, about 150 to about 200 water molecules, about 200 to about 250 water molecules, about 250 to about 300 water molecules, about 300 to about 350 water molecules, about 350 to about 400 water molecules, about 400 to about 450 water molecules, or about 450 to about 500 water molecules.

In some embodiments, the ultrafine bubbles fully dissolve, surround, and/or stabilize a non-gaseous solute. In other embodiments, the ultrafine bubbles substantially dissolve, surround, and/or stabilize a non-gaseous solute (e.g., dissolve, surround, and/or stabilize about 50%, 55%, 60%, 65%, 70%, 80%, 85%, 90%, 95% or more of the non-gaseous solute).

Those skilled in the art will recognize different ways of measuring particle size distribution of an ultrafine bubble suspension of the disclosure. In an exemplary method a particle size distribution of an ultrafine bubble suspension is measured using a Malvern Instruments Zetasizer Nano ZSP, which is a high-performance system and particularly suitable for the characterization of ultrafine bubbles. Alternatively, the concentration and particle size distribution of an ultrafine bubble suspension of the disclosure may be measured using a Malvern Instruments Nanosight NTA instrument. In another exemplary method a diameter of an ultrafine bubble is measured using liquid-cell transmission electron microscopy (TEM). Additionally, the size distribution and concentration of an ultrafine bubble suspension may be measured on a particle-by-particle basis using tunable resistive pulse sensing (TRPS) or electrical zone sensing, using such instruments as the Izon Exoid or the Beckman Coulter Multisizer 4e, respectively.

In some embodiments, the ultrafine bubble and solutes of the disclosure are measured according to the following non-limiting parameters: ultrafine bubble diameter, particle and molecule size, translational diffusion, electrophoretic mobility, zeta potential of particles at high and low concentrations, viscosity and viscoelasticity of protein and polymer solutions, concentration, and/or molecular weight (e.g., kD).

In some embodiments, the ultrafine bubbles (e.g., ultrafine bubbles comprising or consisting essentially of water and gases released from solution in water) are stable for an extended storage period including, for example, a period of years. In some embodiments, the ultrafine bubbles are stable for about 2 years, about 2.5 years, about 3 years, about 4 years, about 5 years, about 6 years, about 7 years, about 8 years, about 9 years, or about 10 years. In some embodiments, the ultrafine bubbles are stable for a period in excess of 10 years.

In some embodiments, the ultrafine bubbles dissolve, surround, and/or stabilize a non-gaseous solute for a period of years, for example for about 2 years, about 2.5 years, about 3 years, about 4 years, about 5 years, about 6 years, about 7 years, about 8 years, about 9 years, or about 10 years. In further embodiments, the ultrafine bubbles dissolve, surround, and/or stabilize a non-gaseous solute for a period in excess of 10 years.

In some embodiments, the disclosure provides compositions or solutions for use in delivering a non-gaseous solute to the interior of a cell such as a plant or animal (e.g, mammalian including human cell). In other embodiments, the disclosure provides compositions or solutions for use in delivering a non-gaseous solute to the interior of a plant or an animal cell.

Embodiments of the disclosure include compositions or solutions wherein a non-gaseous solute is dissolved within, surrounded by, and/or stabilized by ultrafine bubbles and has improved bioavailability relative to a composition or a solution where the non-gaseous solute is not dissolved by, surrounded by, and/or stabilized by ultrafine bubbles. In some embodiments, the non-gaseous solute dissolved within, surrounded by, and/or stabilized by ultrafine bubbles has improved bioavailability by virtue of its ability to access the interior of a cell. For example, a water having a non-gaseous solute is typically incapable of passing through a cell membrane, but non-gaseous solutes dissolved within, surrounded by, and/or stabilized by the ultrafine bubbles of the disclosure are able to cross a cell membrane; i.e., they increase cell permeability. In some embodiments, a cell membrane may be a plasma membrane, a nuclear membrane, a cell wall, or any other impermeable barrier defining the boundaries of a cell or an organelle within a cell.

In other embodiments, a non-gaseous solute dissolved within, surrounded by, and/or stabilized by ultrafine bubbles has improved bioavailability by virtue of its ability to access an intracellular space. In still other embodiments, the solute dissolved within, surrounded by, and/or stabilized by ultrafine bubbles has improved bioavailability by virtue of its ability to access specific plant or animal tissue types, such as root or leaf tissue in a plant, or skin or internal organ tissues in an animal. In yet other embodiments, an ultrafine bubble comprising or consisting essentially of water and gases released from solution in water and gases released from solution in the ultrapure water has improved bioavailability relative to an ultrafine bubble that does not comprise ultrapure water.

In some embodiments, the compositions including ultrafine bubbles and dissolved, surrounded, and/or stabilized non-gaseous solutes have improved bioavailability relative to naturally occurring water and dissolved solutes. In some embodiments, the ultrafine bubbles and dissolved, surrounded, and/or stabilized non-gaseous solutes provided herein render an otherwise unavailable non-gaseous solute bioavailable, in which case the disclosure provides improved bioavailability of the solute relative to the non-gaseous solute that is not dissolved by, surrounded by, and/or stabilized by ultrafine bubbles. In other embodiments, the ultrafine bubbles comprising or consisting essentially of water and gases released from solution in water, wherein the ultrafine bubbles dissolve, surround, and/or stabilize a non-gaseous solute improve bioavailability of the solute by about 10%, about 20%, about 30%, about 40%, about 50%, about 60%, about 70%, about 80%, or about 90% relative to the solute that is not dissolved within, surrounded by, and/or stabilized by ultrafine bubbles. In further embodiments, the ultrafine bubbles comprising or consisting essentially of water and gases released from solution in water and dissolved, surrounded, and/or stabilized non-gaseous solutes improve bioavailability of the solute by about 1%, about 2%, about 3%, about 4%, about 5%, about 6%, about 7%, about 8%, or about 9%.

In some embodiments, the disclosure provides methods for improving the bioavailability of a non-gaseous solute, including, for example, dissolving the solute in water and dissolving, surrounding, and/or stabilizing the solute with the ultrafine bubbles disclosed herein, wherein the ultrafine bubble has a median diameter between about 2 to about 400 nanometers.

In some embodiments, the compositions having a solute dissolved within, surrounded by, and/or stabilized by ultrafine bubbles have improved stability relative to compositions having the solute that is not dissolved within, surrounded by, and/or stabilized by ultrafine bubbles. In some embodiments, the solute dissolved within, surrounded by, and/or stabilized by ultrafine bubbles with improved stability has an increased half-life, such as an increased serum half-life or solution half-life. In some embodiments, the solute dissolved within, surrounded by, and/or stabilized by ultrafine bubbles has improved stability for extended storage periods relative to the solute that is not dissolved within, surrounded by, and/or stabilized by ultrafine bubbles.

In some embodiments, the compositions or solutions including ultrafine bubbles and a solute dissolved within, surrounded by, and/or stabilized by ultrafine bubbles have improved solubility relative to compositions or solutions including the solute that is not dissolved within, surrounded by, and/or stabilized by ultrafine bubbles. In other embodiments, a solute dissolved within, surrounded by, and/or stabilized by ultrafine bubbles comprises a drug with increased solubility, improved pharmacokinetics, and/or increased bioavailability. As such, embodiments of the disclosure have applications where improved solubility, pharmacokinetics, and/or bioavailability is desired, for example, without limitation, in medical products, patient care, medical research, medical testing, medical equipment, cell culture, and surgical procedures.

In some embodiments, the solute dissolved within, surrounded by, and/or stabilized by ultrafine bubbles normally has limited or no solubility in water but is solubilized when dissolved within, surrounded by, and/or stabilized by ultrafine bubbles. In alternative embodiments, the solute dissolved within, surrounded by, and/or stabilized by ultrafine bubbles may have low to moderate solubility in water but is solubilized (e.g., completely solubilized) when dissolved within, surrounded by, and/or stabilized by ultrafine bubbles comprising or consisting essentially of water and gases released from solution in water.

In some embodiments, a non-gaseous solute of the disclosure further comprises a surface coating applied before or after dissolving, surrounding, and/or stabilizing the solute with ultrafine bubbles. For biological applications, such as proteins, the surface coating may be polar to give high aqueous solubility and prevent particle aggregation.

The disclosure also provides pharmaceutical compositions including ultrafine bubbles where the ultrafine bubbles have a median ultrafine bubble diameter of between about 2 to about 400 nanometers and one or more active pharmaceutical ingredients dissolved within, surrounded by, and/or stabilized by the ultrafine bubbles. In some embodiments, the active pharmaceutical ingredient is selected from a small molecule drug, a protein, a peptide, or a combination thereof. In other embodiments, the pharmaceutical ingredient is a cellular detoxification agent, a hydration agent, an anti-inflammatory agent, a neuroprotective agent, a neuromodulatory agent, or an anti-tumorigenic agent.

In some embodiments, the disclosure provides compositions or solutions used for delivering a therapeutic agent, medicament, drug, or the like, to a subject in need thereof. In some embodiments, an isotonic saline dissolved within, surrounded by, and/or stabilized by ultrafine bubbles is used for improving a drug for intravenous use in a mammal. In certain embodiments, a drug dissolved within, surrounded by, and/or stabilized by ultrafine bubbles is used to increase solubility of the drug. In certain embodiments, an oral drug dissolved within, surrounded by, and/or stabilized by ultrafine bubbles increases bioavailability of the oral drug. Furthermore, in certain embodiments, a drug dissolved within, surrounded by, and/or stabilized by ultrafine bubbles is used as a means for increasing potency of the drug.

In some embodiments, the compositions and solutions of the disclosure are suitable for oral or sublingual delivery, transdermal delivery, or delivery by inhalation (e.g., by nasal inhalation).

In some embodiments, the present disclosure provides a drink (e.g., a hydration, sports, or energy drink) that includes a solute dissolved within, surrounded by, and/or stabilized by ultrafine bubbles comprising or consisting essentially of water and gases released from solution in water. In some embodiments, the solute comprises potassium chloride, vitamin B6, ferric chloride, magnesium sulfate, sodium chloride, Ionic Trace Minerals, kelp, taurine, alfalfa, or sodium borate. In other embodiments, the solute comprises capsaicin, resveratrol, quercetin, vitamin d3, and Panax ginseng. In still other embodiments, the solute comprises synapta, magnesium chloride, Concentrated Trace Minerals, and sodium benzoate. In some embodiments, the solute provides a means for increasing growth and body weight in mammals including humans and animals.

In yet another embodiment, the disclosure provides a hydration, sports, or energy drink comprising water and ultrafine bubbles, wherein the concentration of ultrafine bubbles is up to 10⁸ ultrafine bubbles/mL. In another embodiment, the disclosure provides a hydration, sports, or energy drink including ultrafine bubbles comprising or consisting essentially of water, gases released from solution in water, and a non-gaseous solute, wherein the ultrafine bubbles dissolve, surround, and/or stabilize the solute, and wherein the solute comprises a combination of ions (e.g., cations or ions). In some embodiments, the ion is selected from the group consisting of an aluminum cation, an antimony cation, an arsenic cation, a barium cation, a beryllium cation, a bismuth cation, a boron ion, a bromide anion, a cadmium cation, a calcium cation, a cerium cation, a cesium cation, a chloride anion, a chromium cation, a cobalt cation, a copper cation, a dysprosium cation, an erbium cation, a europium cation, a fluoride anion, a gadolinium cation, a gallium cation, a germanium cation, a gold cation, a hafnium cation, a holmium cation, an indium cation, a iodine anion, an iridium cation, an iron cation, a lanthanum cation, a lead cation, a lithium cation, a lutetium cation, a magnesium cation, a manganese cation, a mercury cation, a molybdenum cation, a neodymium cation, a nickel cation, a niobium cation, an osmium cation, a palladium cation, a phosphorus anion, a platinum cation, a potassium cation, a praseodymium cation, a rhenium cation, a rhodium cation, a rubidium cation, a ruthenium cation, a samarium cation, a scandium cation, a selenium cation, a silicon cation, a silver cation, a sodium cation, a strontium cation, a sulfate anion, a tantalum cation, a tellurium cation, a terbium cation, a thallium cation, a thorium cation, a thulium cation, a tin cation, a titanium cation, a tungsten cation, a vanadium cation, a ytterbium cation, a yttrium cation, a zinc cation, and a zirconium cation.

In alternative embodiments, the ion is selected from the group consisting of aluminum cation, an antimony cation, a barium cation, a bismuth cation, a boron ion, a bromide anion, a calcium cation, a cerium cation, a cesium cation, a chloride anion, a chromium cation, a cobalt cation, a copper cation, a dysprosium cation, an erbium cation, a europium cation, a fluoride anion, a gadolinium cation, a gallium cation, a germanium cation, a gold cation, a hafnium cation, a holmium cation, an indium cation, a iodine anion, an iridium cation, an iron cation, a lithium cation, a lutetium cation, a magnesium cation, a manganese cation, a molybdenum cation, a neodymium cation, a niobium cation, an osmium cation, a palladium cation, a phosphorus anion, a platinum cation, a potassium cation, a praseodymium cation, a rhenium cation, a rhodium cation, a rubidium cation, a ruthenium cation, a samarium cation, a scandium cation, a selenium cation, a silicon cation, a silver cation, a sodium cation, a strontium cation, a sulfate anion, a tantalum cation, a tellurium cation, a terbium cation, a thulium cation, a tin cation, a titanium cation, a tungsten cation, a vanadium cation, a ytterbium cation, a yttrium cation, a zinc cation, and a zirconium cation.

In still other embodiments, the ion is selected from the group consisting of an antimony cation, a barium cation, a bismuth cation, a boron ion, a bromide anion, a calcium cation, a cerium cation, a chloride anion, a chromium cation, a cobalt cation, a copper cation, a europium cation, a fluoride anion, a gold cation, a iodine anion, an iron cation, a lithium cation, a magnesium cation, a manganese cation, a molybdenum cation, a an osmium cation, a palladium cation, a phosphorus anion, a platinum cation, a potassium cation, a rubidium cation, a ruthenium cation, a scandium cation, a selenium cation, a silicon cation, a silver cation, a sodium cation, a strontium cation, a sulfate anion, a tantalum cation, a tin cation, a titanium cation, a tungsten cation, a vanadium cation, and a zinc cation.

The disclosure also provides compositions and solutions for use in agricultural applications. In some embodiments, the disclosure provides compositions or solutions for use in fertilizer delivery, soil or plant hydration, heat tolerance, or seed germination. In further embodiments, the disclosure provides compositions or solutions for use in livestock management, such as livestock feed or drug administration.

In still other embodiments, the disclosure provides a composition or solution that includes a non-gaseous solute dissolved within, surrounded by, and/or stabilized by ultrafine bubbles comprising or consisting essentially of water and gases released from solution in water, wherein the solute comprises a plant or crop fertilizer. In some embodiments, the solute is used for increasing root development in plants, to increase leaf development in plants, for increasing water uptake in plants, for increasing drought tolerance in plants, for increasing crop yields in plants, for increasing the rate of tree growth, for increasing fruit production from trees, for improving sweetness of grapes on grape vines, and/or to generally improve the quality of agricultural products.

In certain embodiments, the solute is selected from nitrogen, phosphorous, potassium, calcium, magnesium, ammonium, sulfur, copper, iron, manganese, molybdenum, zinc, boron, silicon, cobalt, vanadium and/or urea. In certain embodiments, the solute comprises a plant nutritional agent.

### Process for Making Compositions Comprising Ultrafine Bubbles

The present disclosure also provides a process of making a composition or solution comprising water and ultrafine bubbles that may optionally dissolve, surround, and/or stabilize a solute. In some embodiments, a water supply is subjected to a combination of hydrodynamic cavitation, shear forces, and low pressure/room temperature boiling to form ultrafine bubbles, and the formed ultrafine bubbles from the water supply are added to the water of the composition. In some embodiments, a water supply is subjected to processing that forms ultrafine bubbles via gaseous cavitation, and the formed ultrafine bubbles from the water supply are added to the water of the composition.

In another aspect disclosed herein, a method for producing a composition comprising water and ultrafine bubbles (e.g., ultrafine bubbles including gases released from solution in water) is provided. The method includes subjecting water to a combination of hydrodynamic cavitation, shear forces, and low pressure/room temperature boiling to produce ultrafine bubbles formed by release of dissolved gases from the water. In some embodiments, the water is selected from DI water, ultrapure water, tap water, groundwater (e.g., well water), surface water, and reverse osmosis water. In particular embodiments, the water is ultrapure water. In some embodiments, the water is tap water.

The method may comprise one or more (including all) of the following steps: adding water to a tank; pumping the water at a selected flow rate through a transfer pipe from the tank to a nozzle with one jet opening or a plurality of jet openings inside a hollow cylinder; using the one jet opening or the plurality of jet openings in the nozzle to jet the water into the hollow cylinder; wherein the selected flow rate creates a vortex of the water inside the hollow cylinder, thereby subjecting the water to a combination of hydrodynamic cavitation, shear forces, and thin film boiling to produce ultrafine bubbles formed by release of dissolved gases from the water (i.e., gaseous cavitation). The process according to certain embodiments may further comprise collecting the composition comprising the water and ultrafine bubbles; and using the ultrafine bubbles of the composition to dissolve, surround, and/or stabilized a non-gaseous solute to improve the bioavailability of the solute.

In some embodiments, a water supply is subjected to a combination of hydrodynamic cavitation, shear forces, and low pressure/room temperature boiling to form ultrafine bubbles, and the formed ultrafine bubbles from the water supply are added to water to form the composition. In some embodiments, a water supply is subjected to processing that forms ultrafine bubbles via gaseous cavitation, and the formed ultrafine bubbles from the water supply are added to water to form a composition as set forth herein. In other embodiments, ultrafine bubbles comprising water and gases released from solution in a first water source are added to a second water source to make compositions as set forth herein. In some embodiments, a non-gaseous solute is added to the composition including the formed ultrafine bubbles and the water supply to dissolve, surround, and/or stabilize the non-gaseous solute with the formed ultrafine bubbles.

The present disclosure also provides methods for dissolving, surrounding, and/or stabilizing a non-gaseous solute with ultrafine bubbles comprising or consisting essentially of water and gases released from solution in water.

In some embodiments, the disclosure provides a process for dissolving, surrounding, and/or stabilizing a non-gaseous solute with ultrafine bubbles comprising or consisting essentially of water and gases released from solution in water, the process comprising: selecting an amount of solute to add to a volume of water; combining the solute and water in a mixing tank to form a blended aqueous composition; pumping the blended aqueous composition at a selected flow rate through a transfer pipe from the mixing tank to a nozzle with one jet opening or a plurality of jet openings inside a hollow cylinder; using the one jet opening or the plurality of jet openings in the nozzle to jet the blended aqueous composition into the hollow cylinder; wherein the selected flow rate creates a vortex of the blended aqueous composition inside the hollow cylinder that dissolve, surround, and/or stabilizes the solutes and reduce sizes of the ultrafine bubbles in the blended aqueous composition. The process according to certain embodiments may further comprise collecting the composition comprising the solute dissolved within, surrounded by, and/or stabilized by the ultrafine bubbles; and using the reduced size ultrafine bubbles dissolving, surrounding, and/or stabilizing the solute to improve the bioavailability of the solute.

In some embodiments, a process is provided for reducing the size of ultrafine bubbles in a solution of water substantially free of dissolved non-gaseous solutes comprising pumping water at a selected flow rate through a transfer pipe to a nozzle with one jet opening or a plurality of jet openings inside a hollow cylinder; using the one jet opening or the plurality of jet openings in the nozzle to jet the blended composition into the hollow cylinder; wherein the selected flow rate creates a vortex of the blended composition inside the hollow cylinder that reduces the size of the ultrafine bubbles in the blended composition.

In another aspect disclosed herein, a method for producing a composition comprising water and ultrafine bubbles including gases released from solution in water is provided. The method includes subjecting water to a combination of hydrodynamic cavitation, shear forces, and low pressure/room temperature boiling to produce ultrafine bubbles formed by release of dissolved gases from the water. In some embodiments, the water is selected from DI water, ultrapure water, tap water, groundwater (e.g., well water), surface water, and reverse osmosis water. In particular embodiments, the water is ultrapure water.

In some embodiments of the methods, the methods further comprise concentrating the ultrafine bubbles within the composition via rotary evaporation or cross flow filtration.

In another aspect disclosed herein, the disclosure relates to a novel formulation method designed to preserve ultrafine bubbles indefinitely within a solution. The formulation consists of an ultrafine bubble suspension combined with an ingredient that increases the viscosity of the final product. By enhancing the viscosity, the mobility of the ultrafine bubbles is restricted, effectively preventing them from bursting or coalescing. This stabilization mechanism ensures that the ultrafine bubbles remain uniformly dispersed within the solution over extended periods, making the formulation suitable for various applications, including skincare, pharmaceutical, and consumable products.

The key innovation lies in the use of viscosity modifiers that interact with the ultrafine bubbles, creating a stable environment that counters the natural tendencies of these bubbles to merge or collapse. The result is a formulation with enhanced shelf life and consistent performance, providing long-lasting efficacy in delivering active ingredients or maintaining the structural integrity of the product.

Viscosity increasing compounds commonly used in food and cosmetic formulations to increase viscosity include: polysaccharides, including xanthan gum, guar gum, carrageenan, agar-agar, alginate, pectin; cellulose derivatives including hydroxyethylcellulose (HEC), carboxymethylcellulose (CMC), methylcellulose; proteins, including gelatin, collagen, whey protein concentrate; synthetic polymers including carbomers, polyacrylamide, polyvinyl alcohol (PVA), and polyethylene glycol (PEG); natural gums and resins, including, gellan gum, Arabic gun. Tragacanth gum, and vegetable glycerin; lipids and waxes including beeswax, steric acid, cetyl alcohol; starches including corn starch, potato starch, tapioca starch and silicates, including magnesium aluminum silicate, bentonite clay. The formulation includes an ultrafine bubble suspension and a viscosity-increasing ingredient, wherein the ultrafine bubbles are preserved indefinitely within the solution due to inhibited bursting or coalescence. Additionally, the method of stabilizing ultrafine bubbles in a solution includes incorporating a viscosity-increasing agent, thereby preventing the coalescence or bursting of the bubbles, ensuring long-term stability and efficacy of the formulation. The present disclosure further includes skincare or consumable products formulated with an ultrafine bubble suspension and a viscosity modifier, wherein the ultrafine bubbles remain stable and uniformly dispersed for extended periods, enhancing the product's performance and shelf life, and methods for preparing a stable ultrafine bubble suspension in a viscous medium, wherein the increased viscosity prevents bubble coalescence, enabling the formulation's use in diverse applications, including topical, oral, or other administration forms.

This disclosure is further illustrated by the following examples which are provided to facilitate the practice of the disclosed methods. These examples do not limit the scope of the disclosure in any way.

### EXAMPLES

### Example 1: Methods of Making Compositions Including Water and Ultrafine Bubbles

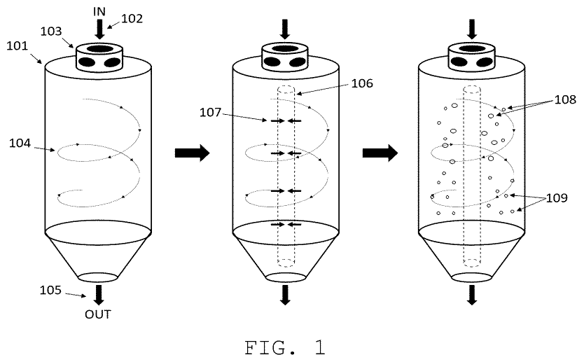

With reference to FIG. 1, a system (101) and a process for making compositions including water and ultrafine bubbles in accordance with embodiments of the disclosure is provided. Water enters the system (101) at step (102) via the nozzle (103) and imparts a vortex flow (104). The vortex core (106) forms as dissolved gases are drawn out of solution due to low pressure at the center (107). Without being bound by theory, it is believed micro- and ultrafine bubbles form (108) spontaneously due to low pressures near to core surface, due to gas being sheared from the core surface, and/or due to room-temperature low pressure boiling at the core surface. Shear and drag forces are believed to break the microbubbles into ultrafine bubbles resulting in a near uniform size distribution (109). The resulting composition including water and ultrafine bubbles flows from the system (101) via the exit (105).

In an embodiment of the invention, a non-gaseous solute (e.g., zinc sulfate) is added to the water prior to its entry to the system 101 at step 102, and the resulting composition including water, ultrafine bubbles, and the non-gaseous solute (e.g., zinc sulfate) flows from the system (101) via the exit (105). The ultrafine bubbles of the composition dissolve, surround, and/or stabilize the non-gaseous solute.

In another embodiment of the invention, a non-gaseous solute (e.g., zinc sulfate) is added to a composition including water and ultrafine bubbles after the composition exits from the system (101) via the exit (105). The ultrafine bubbles of the composition dissolve, surround, and/or stabilize the non-gaseous solute.

In another embodiment of the invention, the system (101) is used to produce an ultrafine bubble suspension or composition comprising water and ultrafine bubbles. The ultrafine bubbles from the ultrafine bubble suspension or composition comprising water and ultrafine bubbles are then added to a different source of water.

In another embodiment of the invention, the water is “enriched” with microbubbles (bubbles greater than one micron and less than a millimeter in diameter) prior to entering the system (101) via the nozzle (103). These bubbles may be added from an exogenous source such as a microbubble generator, venturi, or porous bubbler/membrane in-line or into a tank before processing. The resulting composition exiting via the exit (105) may have higher concentrations of ultrafine bubbles as a result (e.g., greater than 10⁸ ultrafine bubbles/mL). In some embodiments, the compositions have between about 10⁸ ultrafine bubbles/mL and 10¹¹ ultrafine bubbles/mL. Without being bound by theory, it is believed this is due to the breakup of the microbubbles into ultrafine bubbles while passing through the system (101) as the microbubbles are exposed to drag forces. Furthermore, by creating microbubbles from specific gases, particularly gases that do not readily dissolve into water (e.g. ozone), the composition of the resulting ultrafine bubbles may be controlled or tailored to include a wider range of gases than are present in the atmosphere.

In another embodiment of the invention, the water is sparged with one or more specific gases prior to entering the system (101) via the nozzle (103). In some embodiments, the resulting composition of gases contained within the ultrafine bubbles is tailored. In some embodiments, the sparging gases may include, but not be limited to, one or more of O₂, O₃, CO₂, N₂, N₂O, Ar, or any mixture containing those gases. For example, when O₂ gas and N₂ gas are sparged or bubbled in water in order to saturate the water prior to undergoing the process within system (101), the resulting composition will have a higher concentration of O₂ and N₂ ultrafine bubbles than if the water had only been exposed to the atmosphere. Such a resulting composition may have particular benefits, such as increasing plant growth upon application.

In another embodiment of the invention, enrichment with large ultrafine bubbles (>100 nm) is carried out using various methods before entering the vortexing/hydrodynamic cavitation system (101). These methods, such as pressurization, gas injection, or mechanical agitation, introduce these larger bubbles into the solution. During the subsequent treatment, these large bubbles are then broken down into smaller ones (<100 nm) through hydrodynamic cavitation and shear. This dual-stage process not only increases the overall concentration of bubbles in the solution but also allows for precise customization of bubble compositions.

The implications of this advancement are significant. By starting with larger bubbles and refining them into smaller ones through cavitation and shear forces, this method provides a more controlled and efficient means of bubble manipulation. This level of control enables the tailoring of bubble properties to match specific application requirements, such as in biomedical applications, environmental remediation, or industrial processes. Additionally, the increased concentration of smaller bubbles enhances the effectiveness of bubble-based treatments, potentially leading to improved outcomes and efficiency in various fields of application.

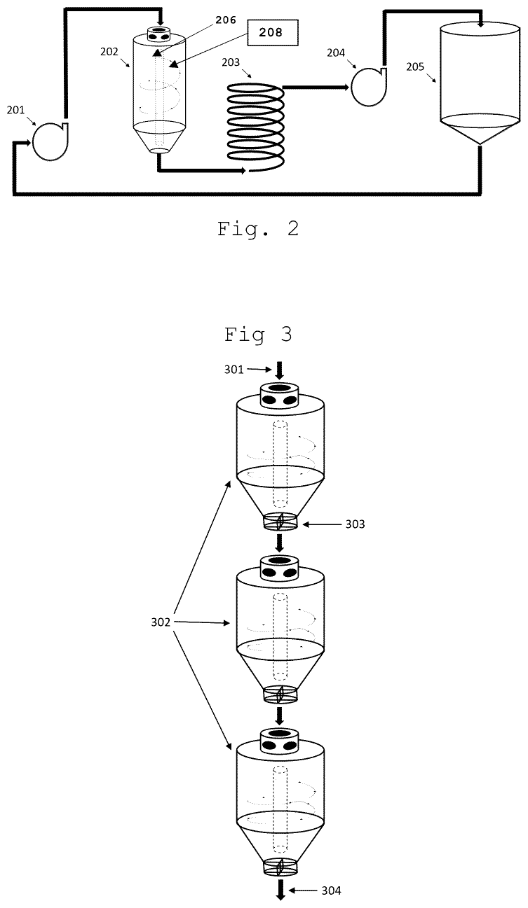

In another embodiment of the disclosure shown in FIG. 2, after creating ultrafine bubbles through vortexing/hydrodynamic cavitation, these bubbles, along with possibly the vortex core (206), are kept under a partial vacuum for some time. This is done by placing the suction side of a pump (204) at the outlet of the cavitation device (202). The partial vacuum helps maintain the stability and concentration of the bubble suspension (208). Adjusting the concentration of the bubble suspension (208) is accomplished by controlling either how long the bubble suspension stays in the vacuum (203) or the distance it travels through the vacuum. Moreover, the vortex core (206) may continue into the dwell tubing beyond the technical exit. This method permits customization of the properties of the suspension for specific needs, by utilizing either a single self-priming pump (204) (like a positive displacement pump) after vortexing/hydrodynamic cavitation treatment or using two pumps in a push-pull setup with a first pump (201) before vortexing/hydrodynamic cavitation treatment and a second pump (204) after the vortexing/hydrodynamic cavitation treatment, respectively.

In another embodiment of the invention, highly concentrated bubble suspensions are achieved by circulating the ultrafine bubble suspension through the hydrodynamic cavitation device (202) and suction pump (201), (204) multiple times using a reservoir (205) as described above for FIG. 2.

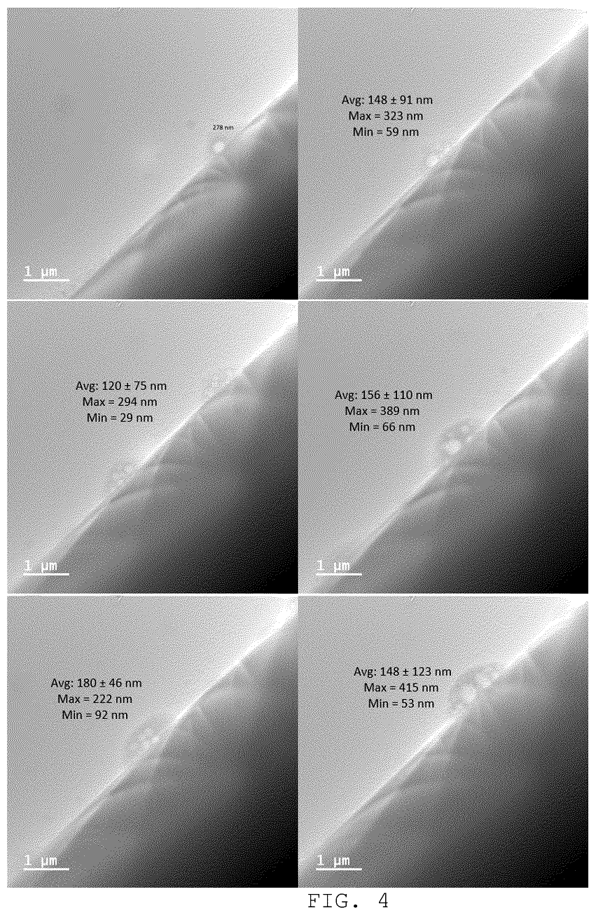

FIG. 3 illustrates an alternative approach for creating highly concentrated bubble suspensions, which involves passing water (301) through multiple vortexing/hydrodynamic cavitation treatment devices (302) set up in a series or sequence. To achieve this, arrestors (303) are utilized to halt the flow rotation of the bubble suspension at the end of each treatment, while multiple pumps (201), (204) are utilized to sustain the vacuum. This sequential setup or recirculation approach provides scalability and efficiency in generating highly concentrated bubble suspensions, reaching up to 10¹¹ bubbles per milliliter.

The ultrafine bubbles produced through the described methods were examined using liquid cell transmission electron microscopy (LC-TEM) techniques, either by flowing the suspension through a commercially available flow cell or by capturing a portion of the suspension within graphene sheet envelopes. In the case of the commercially available flow cell, the flow rate of the suspension was set at 150 mL/hr using a syringe pump, with a microchip cell featuring a 500 nm spacer and a volume of approximately 2 nL. (FIG. 4). However, observations revealed that the bubbles were predominantly concentrated along the edges of the cell, with limited visibility in the middle due to the high liquid thickness, hindering accurate concentration determination. The size distribution of the bubbles ranged from approximately 30 to 400 nm, making it challenging to count them accurately via traditional methods, especially considering the resolution limitations of most current techniques.

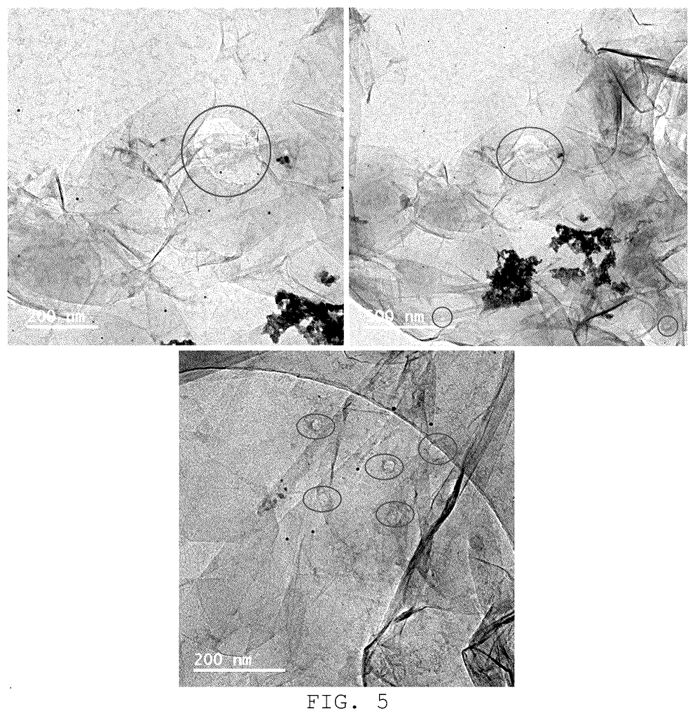

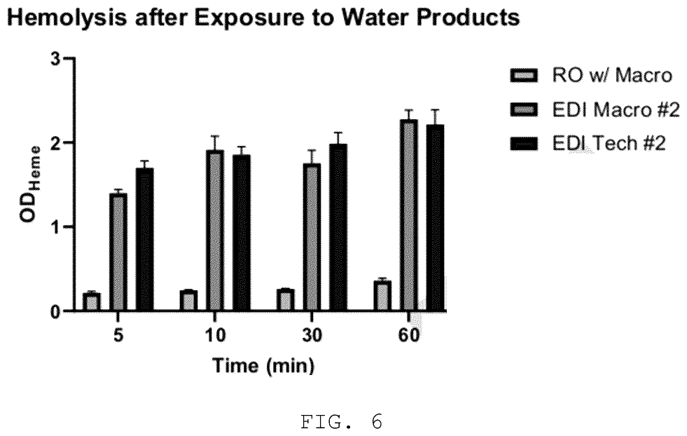

In the graphene sheet envelope experiments, excluding larger bubbles (˜160 nm), the observed bubble size distribution was around 30±7 nm. (FIG. 5) This narrow size range poses difficulties for conventional bubble counting methods like Nanoparticle Tracking Analysis (NTA), Tunable Resistive Pulse Sensing (TRPS), or Multi-resistive Pulse Sensing (MRPS), as these techniques typically achieve optimal resolution only down to 50 nm. These results underscore the need for innovative approaches to accurately quantify and characterize the ultrafine bubbles generated through the present method, especially considering their potential applications in various industries.

### Example 2: Water Composition Hydration Over Time Study

Red blood cells (RBCs) are sensitive to osmotic change and can serve as models for hydration ability, as they release Heme upon lysis (which may occur as a result of rapid increase in hydration). Water compositions were prepared and assessed for ability to hydrate red blood cells in vitro. Three water compositions were prepared with added electrolytes in concentrations as shown in Table 1:
Composition 1) a reverse osmosis (RO) water with added electrolytes (RO w/Macro);
Composition 2) a deionized (DI) water composition prepared according to the disclosure, wherein the electrolytes were added after the water composition was prepared according to the disclosure (EDI Macro #2); and

TABLE 1
Electrolyte composition added to water compositions

| | Conc |
|---|---|
| Ion | [mg/L] |
| Magnesium | 22.6 |
| Sodium | 155.5 |
| Potassium | 9.6 |
| Chloride | 65.6 |
| Sulfate | 3.0 |
| Benzoate | 62.9 |
| Bicarbonate | 362.6 |

1 mL of human whole blood K2EDTA was lysed with 1% Triton X-100 and centrifuged to collect the supernatant. Presence of Heme was measured at different dilutions of the supernatant by reading absorbance at 416 nm using an H1 Synergy Plate Reader to create a negative control.

Blood samples (K2EDTA) for testing hydration capabilities of the different water compositions over time were prepared by diluting the blood with a hypertonic solution to 6% (i.e., the RBCs were shriveled). The three water composition samples were added to respective blood samples, which were then incubated, centrifuged, and the supernatant removed and analyzed for absorbance at 416 nm (to recognize Heme content). Hemolysis analysis was run at 5 minutes, 10 minutes, 30 minutes, and 60 minutes of exposure to the water compositions to determine if hemolysis is dependent upon exposure to the water compositions over time.

As displayed in FIG. 6, each of the sample compositions demonstrated a time-dependent increase in hydration. However, the RO w/Macro sample (i.e., not prepared in accordance with the present disclosure) had the lowest Heme signal at all time points, demonstrating limited potential for hydration even after an extended period of time. The EDI Tech #2 sample, demonstrated the highest Heme signal at 5 minutes, indicating a strong hydration potential even after only 5 minutes of exposure to the RBCs. The EDI Tech #2 sample also demonstrated a small time-dependent increase in hemolysis, but by 60 minutes the EDI Macro #2 had reached the same hydration potential as the EDI Tech #2 sample. Thus, the EDI Tech #2 was capable of significant hydration even at short durations of exposure.

### Example 3: Beverage Composition Hydration Study

Beverage compositions were prepared by blending 8.1 mg calcium chloride dihydrate, 6.1 mg sodium bicarbonate, 9.0 mg magnesium sulfate heptahydrate, and 2.8 mg zinc sulfate monohydrate into 500 mL conventional purified water (control beverage), or by blending 8.1 mg calcium chloride dihydrate, 6.1 mg sodium bicarbonate, 9.0 mg magnesium sulfate heptahydrate, and 2.8 mg zinc sulfate monohydrate into 500 mL of a composition prepared according to the disclosure (investigational beverage).

Healthy adult male participants were randomly assigned in a double-blind manner to consume the control beverage or the investigational beverage over the course of the study. The degree of hydration in the participants after consuming either the investigational beverage or the control beverage was measured before, during, and after exercise for each of the participants, and a number of hydration-related characteristics were assessed.

Participants who consumed the investigational beverage had an average 1.7% decrease in blood serum osmolality from pre-exercise to two hours post-exercise versus an average 1.1% decrease in the control beverage group. Moreover, a greater proportion of participants in the investigational beverage group (87%) than in the control beverage group (67%) had a decrease in blood serum osmolality at two hours post-exercise.

Participants who consumed the investigational beverage had average increases of 5.1% in total body water (TBW) and 5.6% (p=0.478) in intracellular water (ICW) from pre- to two hours post-exercise. In contrast, the participants who consumed the control beverage has only average increases of 2.1% (p=0.011) TBW and 2.0% (p=0.025) ICW from pre- to two hours post-exercise.

A greater proportion of participants who consumed the investigational beverage had an increase in mean corpuscular volume (MCV) from pre- to immediately post-exercise (40%) compared to the group of participants who consumed the control beverage (20%). Additionally, a greater proportion of participants who consumed the investigational beverage had an increase in mean corpuscular volume (MCV) from pre- to two hours post-exercise (40%) compared to the group of participants who consumed the control beverage (33%).

While the present disclosure has been described and illustrated herein by references to various specific materials, procedures and examples, it is understood that the disclosure is not restricted to the particular combinations of materials and procedures selected for that purpose. Numerous variations of such details can be implied as will be appreciated by those skilled in the art. It is intended that the specification and examples be considered as exemplary only, with the true scope and spirit of the disclosure being indicated by the following claims. All references, patents, and patent applications referred to in this application are herein incorporated by reference in their entirety.

1. A composition comprising water and ultrafine bubbles, wherein the ultrafine bubbles comprise the water and gases released from solution in water.

2. The composition of claim 1, wherein the ultrafine bubbles are present in the composition at a concentration of up to 10¹⁰ ultrafine bubbles/mL.

3. The composition of claim 1, wherein the ultrafine bubbles have a median diameter of between about 2 to about 400 nanometers.

4. The composition of claim 1, wherein the ultrafine bubbles remain stable within the composition for at least six months.

5. The composition of claim 1, the composition further comprising at least one non-gaseous solute.

6. The composition of claim 5, wherein the at least one non-gaseous solute is dissolved within, surrounded by, and/or stabilized by the ultrafine bubbles.

7. The composition of claim 6, wherein the composition increases cell permeability and/or bioavailability of the at least one non-gaseous solute.

8. The composition of claim 6, wherein the at least one non-gaseous solute is stable within the composition for at least six months.

9. The composition of claim 1, wherein the ultrafine bubbles are concentrated within the composition via rotary evaporation and/or cross flow filtration.

10. The composition of claim 9, wherein the concentrated ultrafine bubbles are stable within the composition for at least six months.

11. A method for producing a composition comprising water and ultrafine bubbles, the method comprising the steps of:
subjecting water to one or more of hydrodynamic cavitation, shear forces, and low pressure/room temperature boiling to produce ultrafine bubbles formed by release of dissolved gases from the water,
wherein the ultrafine bubbles are formed within the composition at a concentration of up to 10¹⁰ ultrafine bubbles/mL.

12. The method of claim 11, further comprising adding at least one non-gaseous solute.

13. The method of claim 12, wherein the at least one non-gaseous solute is dissolved within, surrounded by, and/or stabilized by the ultrafine bubbles.

14. The method of claim 12, wherein the at least one non-gaseous solute is added before the step of subjecting the water to the one or more of hydrodynamic cavitation, shear forces, and low pressure/room temperature boiling to produce the ultrafine bubbles.

15. The method of claim 12, wherein the at least one non-gaseous solute is added after the step of subjecting the water to the one or more of hydrodynamic cavitation, shear forces, and low pressure/room temperature boiling to produce the ultrafine bubbles.

16. The method of claim 11, further comprising concentrating the ultrafine bubbles within the composition via rotary evaporation or cross flow filtration.

17. The method of claim 11, further comprising the step of enriching the water with microbubbles before the step of subjecting the water to the one or more of hydrodynamic cavitation, shear forces, and low pressure/room temperature boiling to produce the ultrafine bubbles.

18. The method of claim 11, further comprising the step of sparging the water with one or more gases before the step of subjecting the water to the one or more of hydrodynamic cavitation, shear forces, and low pressure/room temperature boiling to produce the ultrafine bubbles.

19. A method for producing a composition comprising water and ultrafine bubbles, the method comprising the steps of:
generating and adding microbubbles to water, and
subjecting the water with the added microbubbles to one or more of hydrodynamic cavitation, shear forces, and low pressure/room temperature boiling to produce ultrafine bubbles formed by release of dissolved gases from the water,
wherein the ultrafine bubbles are formed within the composition at a concentration of up to 10¹¹ ultrafine bubbles/mL.

20. The method of claim 19, further comprising adding at least one non-gaseous solute dissolved within, surrounded by, and/or stabilized by the ultrafine bubbles.

21. The method of claim 19, further comprising concentrating the ultrafine bubbles within the composition via rotary evaporation or cross flow filtration.

22. The method of claim 19, further comprising the step of sparging the water with one or more gases before the step of subjecting the water to the one or more of hydrodynamic cavitation, shear forces, and low pressure/room temperature boiling to produce the ultrafine bubbles.
